(19) United States
(12) Patent Application Publication
(10) Pub. No.: US 2023/0409929 A1
(43) Pub. Date: Dec. 21, 2023

(54) METHODS AND APPARATUSES FOR TRAINING PREDICTION MODEL

(71) Applicant: Alipay (Hangzhou) Information Technology Co., Ltd., Hangzhou (CN)

(72) Inventors: Wenpeng Zhang, Hangzhou (CN); Lihong Gu, Hangzhou (CN); Guannan Zhang, Hangzhou (CN); Jinjie Gu, Hangzhou (CN); Wenliang Zhong, Hangzhou (CN)

(73) Assignee: Alipay (Hangzhou) Information Technology Co., Ltd., Hangzhou (CN)

(21) Appl. No.: 18/337,960

(22) Filed: Jun. 20, 2023

(30) Foreign Application Priority Data
Jun. 20, 2022 (CN) 202210694769.2

(51) Int. Cl. G06N 5/022

(52) U.S. Cl. CPC G06N 5/022

(57) ABSTRACT

A target sample including a sample feature, a first label, and a second label is obtained, where a user corresponds to the target sample, the first label indicates whether a target object is clicked on by the user, and the second label indicates whether the user implements a target behavior related to the target object. Model processing is performed on the sample feature using a prediction model with a first branch and first probability and a second branch and second probability. A first loss is determined based on a first label value and the first probability. When a predetermined condition is satisfied, the second loss is determined based on a second label value of the second label and the second probability, and a predicted loss of the target sample is determined based on the first loss and the second loss. Training the prediction model based on the predicted loss.

### CROSS-REFERENCE TO RELATED APPLICATIONS

This application claims priority to Chinese Patent Application No. 202210694769.2, filed on Jun. 20, 2022, which is hereby incorporated by reference in its entirety.

### TECHNICAL FIELD

One or more embodiments of this specification relate to the artificial intelligence field, and in particular, to methods and apparatuses for training a prediction model for predicting user behaviors.

### BACKGROUND

A post-click conversion rate (CVR) refers to a proportion of cases that users implement a predetermined conversion behavior on a target object after clicking on the target object. The predetermined conversion behavior can include purchase, add to favorites, add to cart, forward, etc. Predicting a CVR is an important and core prediction task in multiple existing technical scenarios. For example, in a recommendation system, CVR predicted values of candidate items to be recommended can be used as important ranking factors to help balance a user's click behaviors and subsequent conversion behaviors.

However, when CVR prediction models are trained by using machine learning methods to predict CVRs, difficulties often occur, including, for example, sparsity of training data and sample selection bias. Consequently, training effects of the CVR prediction models are unsatisfactory.

It is desirable to provide a new solution that can improve training effects of user behavior prediction models, thereby further improving user behavior prediction effects.

### SUMMARY

One or more embodiments of this specification describe methods for training a prediction model, to more efficiently train a prediction model for predicting a user conversion behavior in an entire space.

According to a first aspect, a method for training a prediction model is provided, where the prediction model includes a first branch and a second branch, and the method includes the following: a target sample is obtained, where the target sample includes a sample feature, a first label, and a second label; the first label indicates whether a user corresponding to the target sample clicks on a target object; and the second label indicates whether the user implements a target behavior related to the target object; model processing is performed on the sample feature by using the prediction model so that the first branch outputs a first probability that the user clicks on the target object, and the second branch outputs a second probability that the user implements the target behavior; a first loss is determined based on a first label value of the first label and the first probability; when a predetermined condition is satisfied, a second loss is determined based on a second label value of the second label and the second probability, and a predicted loss of the target sample is determined based on the first loss and the second loss, where the predetermined condition includes the following: the first label value indicates that the user clicks on the target object; and the prediction model is trained based on the predicted loss.

According to some implementations, the method further includes the following: when the predetermined condition is not satisfied, a third loss is determined based on a first product of the first label value and the second label value and a second product of the first probability and the second probability; and the predicted loss is determined based on the first loss and the third loss.

In some embodiments, the predetermined condition further includes the following: the second label value indicates that the user does not implement the target behavior.

In an embodiment, the prediction model further includes an embedding layer; and the model processing includes encoding the sample feature into an embedding vector by using the embedding layer, and inputting the embedding vector separately into the first branch and the second branch.

Further, in an example, the sample feature includes a user feature of the user and an object feature of the target object; and the encoding the sample feature into an embedding vector by using the embedding layer includes the following: encoding the user feature into a first vector; and encoding the object feature into a second vector; and aggregating the first vector and the second vector to obtain the embedding vector.

In a further example, the sample feature further includes an interaction feature of the user and the target object; and the encoding the sample feature into an embedding vector by using the embedding layer further includes the following: encoding the interaction feature into a third vector; where the embedding vector is further obtained based on the third vector.

According to an implementation, the prediction model further includes a gating unit and a product calculation unit; and the gating unit blocks a target path when the predetermined condition is satisfied, and conducts the target path when the predetermined condition is not satisfied, where the target path is used to transmit the first probability and the second probability to the product calculation unit to calculate the second product.

In various embodiments, the target behavior includes one of the following: purchase, add to favorites, add to cart, download, and forward.

According to a second aspect, an apparatus for training a prediction model is provided, where the prediction model includes a first branch and a second branch, and the apparatus includes the following: a sample acquisition unit, configured to obtain a target sample, where the target sample includes a sample feature, a first label, and a second label; the first label indicates whether a user corresponding to the target sample clicks on a target object; and the second label indicates whether the user implements a target behavior related to the target object; a probability prediction unit, configured to perform model processing on the sample feature by using the prediction model so that the first branch outputs a first probability that the user clicks on the target object, and the second branch outputs a second probability that the user implements the target behavior; a first loss determining unit, configured to determine a first loss based on a first label value of the first label and the first probability; a second loss determining unit, configured to, when a predetermined condition is satisfied, determine a second loss based on a second label value of the second label and the second probability, and determine a predicted loss of the target sample based on the first loss and the second loss, where the predetermined condition includes the following: the first label value indicates that the user clicks on the target object; and a training unit, configured to train the prediction model based on the predicted loss.

According to a third aspect, a computer-readable storage medium is provided, where a computer program is stored on the computer-readable storage medium. When the computer program is executed in a computer, the computer is enabled to perform the method according to the first aspect.

According to a fourth aspect, a computing device is provided, including a memory and a processor, where the memory stores executable code, and the processor implements the method according to the first aspect when executing the executable code.

In the training solutions provided in the embodiments of this specification, when a label of a training sample indicates that a corresponding user clicks on a target object, a predicted loss of a CVR prediction task is used instead of a predicted loss of a click-through conversion rate (CTCVR) prediction task. Such practice avoids a gradient conflict between a CTR task and a CTCVR task in this case, thereby achieving a better training effect.

### BRIEF DESCRIPTION OF DRAWINGS

To describe the technical solutions in the embodiments of this invention more clearly, the following briefly describes the accompanying drawings needed for describing the embodiments. Clearly, the accompanying drawings in the following description merely show some embodiments of this invention, and a person of ordinary skill in the art can still derive other drawings from these accompanying drawings without creative efforts.

FIG. 1 is a schematic diagram illustrating an entire-space multi-task model;

FIG. 2 is a summary chart illustrating first gradients and second gradients in cases of various possible values of a first label y and a second label z;

FIG. 3 is a flowchart illustrating a method for training a prediction model, according to an embodiment;

FIG. 4 is a schematic diagram illustrating a structure and a training process of a prediction model; and

FIG. 5 is a schematic structural diagram illustrating a training apparatus, according to an embodiment.

### DESCRIPTION OF EMBODIMENTS

The following describes the solutions provided in this specification with reference to the accompanying drawings.

In typical Internet scenarios, various service platforms present various objects over the Internet. When browsing objects of interest, a user first clicks on the objects to obtain further information or obtain entries to conversions. Then, the user may implement conversion behaviors on some of the objects that are clicked on. For example, in a typical e-commerce scenario, a service platform presents various recommended products. A user clicks on some products of interest among the products, and further may purchase some of the products. Therefore, user behaviors follow a strict sequential pattern, i.e. impression—>click—>conversion.

A service platform concerns a user's conversion rate most, and thus predicting a post-click conversion rate (CVR) is an important task of the service platform. However, as described above, as user behaviors present strict sequentiality, a conversion's sequential dependence on a click makes construction of a CVR prediction model subject to several challenges and difficulties.

One difficulty is scarcity and sparsity of training data. It can be understood that, each impression of an object can contribute to one training sample related to click-through rate (CTR) prediction, that is, presence of a click generates a positive sample, and absence of a click generates a negative sample. However, only an object that a user clicks on after an impression can be used as a training sample for CVR prediction. In practice, an actual proportion of click occurrences is very low. Thus, a quantity of samples available for training for CVR prediction is much smaller than a quantity of samples available for training for CTR prediction.

Another difficulty is sample selection bias. It can be understood that, a trained CVR prediction model needs to perform prediction on an entire space of all impression objects, and it is impossible for the trained CVR prediction model to predict a conversion rate of a user after the user actually clicks on the object. However, as described above, training samples for CVR prediction are only impression objects that are clicked on. Depending on individual selections of different users, an impression object clicked on is usually very different from the entire space of all the impression objects in terms of data distribution characteristics, and a data distribution difference between a training data space and a prediction space can significantly affect prediction performance of the trained CVR model.

To address the above-mentioned difficulties, in an implementation, an entire-space multi-task model is proposed. This model can indirectly perform modeling and training for CVR prediction based on sequential pattern characteristics of user behaviors in the CVR prediction by making good use of a multi-task learning method.

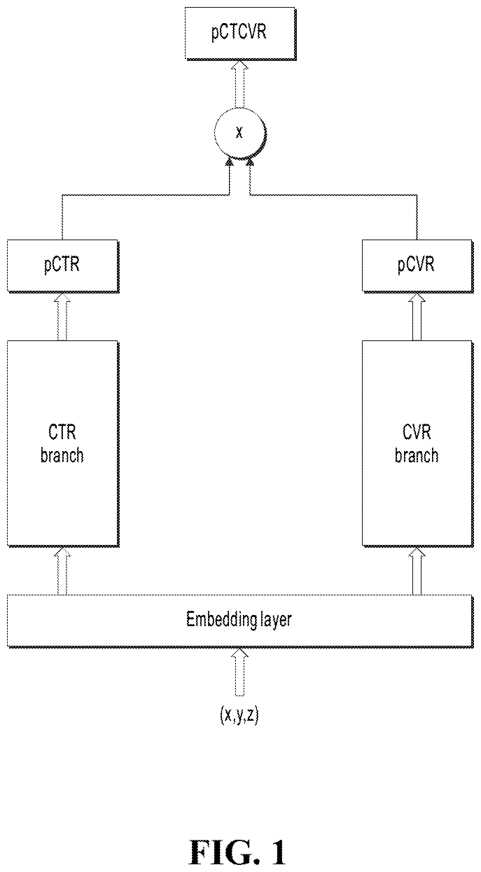

FIG. 1 is a schematic diagram illustrating an entire-space multi-task model. As shown in FIG. 1, the multi-task model includes a shared embedding layer and two prediction branches, i.e. a first branch corresponding to CTR prediction and a second branch corresponding to CVR prediction. The following describes a training process of the model.

A training sample set is first obtained, where each sample user has two labels, which respectively represent whether a click is performed and whether a conversion occurs after the click. As such, any sample i can be represented as (xi, yi, zi), where xi represents a sample feature, for example, a feature of the sample user and an impression object; yi represents, using different values, whether the sample user clicks on the impression object, for example, yi=0 represents no click and yi=1 represents a click; and zi represents whether the sample user implements a target behavior after a click, where the target behavior is considered in a corresponding scenario as a behavior indicating that the user has performed a conversion. For example, in an e-commerce scenario, the target behavior can be purchase or add to cart; and in a recommendation scenario, the target behavior can alternatively be add to favorites or share with friends, etc. A constraint for a behavior sequence pattern based on CVR prediction requires that zi can be equal to 1 only when yi=1; and if yi=0, zi must be 0, i.e. p(z=1|y=0,x)=0. The subscript i is omitted from some of the descriptions below without causing confusion.

When the sample feature x of the training sample is input into the above-mentioned model, the embedding layer performs embedding encoding on the sample feature x and then inputs an obtained embedding vector separately into the CTR branch and the CVR branch. The CTR branch is used to predict a probability that the user clicks on the impression object, to obtain a first probability pCTR, and the first probability can be represented as pCTR=p( [symbol] =1|x). The CVR branch is used to predict a probability that the user (i.e. the user in the case of y=1) implements a conversion behavior after a click, to obtain a second probability pCVR, and the second probability can be represented as pCVR=p(z=1| [symbol] =1,x).

The concept of a total conversion rate CTCVR can be introduced to represent a proportion or probability that a click and then a conversion is are performed on an impression object. Thus, a total probability corresponding to the total conversion rate can be represented as pCTCVR=p(z=1, [symbol] =1|x). According to the chain rule, the following is satisfied between the total probability and the first probability and second probability:

$${\underbrace{\begin{matrix}p & ( z = 1 , y = 1 \vert x )\end{matrix}}}_{pCTCVR} = {\underbrace{\begin{matrix}p & ( y = 1 \vert x )\end{matrix}}}_{pCTR} \times {\underbrace{\begin{matrix}p & ( z = 1 \vert y = 1 , x )\end{matrix}}}_{pCVR} \qquad ( 1 )$$

As shown in FIG. 1, the first probability pCTR predicted by the first branch and the second probability pCVR predicted by the second branch are transmitted to a product calculation unit or operator to obtain the total probability pCTCVR. According to equation (1), the second probability pCVR can be deduced from the total probability pCTCVR and the first probability pCTR. In addition, both the total probability pCTCVR and the first probability pCTR can be modeled based on the entire space formed by all the impression objects. Specifically, for a CTR task, training can be performed based on a sample feature x and a label y of any sample; and for a CTCVR task, training can be performed by using a product y*z of a label y and a label z of any sample as a new label, where the new label must be 0 when y=0 (no click occurs), and the new label is 1 only when both y and z are 1, meaning that the user first performs a click and then a conversion. Therefore, the entire-space multi-task model introduces the pCTR and pCTCVR prediction tasks as auxiliary tasks, and uses a primary task (pCVR prediction) as an intermediate result in a process of the auxiliary tasks. Since both of the pCTR and pCTCVR auxiliary tasks are modeled in the entire space, the derived pCVR is also applicable to the entire space, thereby alleviating the training data sparsity problem and the sample bias problem.

As described above, the entire-space multi-task model is trained based on the two auxiliary tasks. Specifically, the sum of respective predicted losses of the CTR task and the CTCVR task can be used as a total predicted loss to train the model. The total predicted loss can be represented as follows:

Lₑₛₘₘ(Θ)=L_{ctr}(Θ)+L_{ctcvr}(Θ) (2)

Lₑₛₘₘ is the total predicted loss of the entire-space multi-task model, L_{ctr} is the predicted loss of the CTR prediction task, L_{ctcvr} is the predicted loss of the CTCVR task, and Θ is a parameter in the entire model.

Further, L_{ctr} and L_{ctcvr} can be respectively represented as follows:

$${L}_{ctr} ( Θ ) = {\sum }_{i = 1}^{N} l ( {y}_{i} , f ( {x}_{i} ; {θ}_{ctr} , {θ}_{emb} ) ) \qquad ( 3 )$$

$${L}_{ctcvr} ( Θ ) = {\sum }_{i = 1}^{N} l ( {y}_{i} \times {z}_{i} , f ( {x}_{i} ; {θ}_{ctr} , {θ}_{emb} ) \times f ( {x}_{i} ; {θ}_{cvr} , {θ}_{emb} ) ) \qquad ( 4 )$$

θ_{ctr}, θ_{cvr}, θ_{emb} respectively represent a model parameter of the CTR branch, a model parameter of the CVR branch, and a model parameter of the embedding layer, ƒ(⋅) represents a prediction function in the model, and l(⋅) represents a loss function for calculating a predicted loss, for example, a cross entropy loss function or a mean square error loss function. It can be seen from equation (3) that, the predicted loss L_{ctr} of the CTR task is determined based on the first probability pCTR (calculated by using the prediction function) and the label yi. It can be seen from equation (4) that, the predicted loss L_{ctcvr} of the CTCVR task is determined based on the total probability pCTCVR and the new label yi*zi.

However, in practice, the entire-space multi-task model often encounters training difficulties of slow convergence and even convergence failures. The inventor had made in-depth research on these difficulties and found that when training is performed according to equations (2) to (4) above, a serious conflict exists between different tasks with respect to a parameter adjustment direction, i.e. a gradient, of the CTR branch in the model, and the conflict leads to the training difficulty of difficult convergence.

Specifically, for any single sample (with a sample feature x), assuming that a prediction score (i.e. a predicted value of the first probability pCTR) of the model for the CTR task is ƒₜ=ƒ(x;θ_{ctr}, θ_{emb}), and a prediction score (i.e. a predicted value of the second probability pCVR) of the model for the CVR task is ƒᵥ=ƒ(x; θ_{cvr}, θ_{emb}), the predicted loss of the CTR task corresponding to equations (3) and (4) above can be represented as follows:

l_{ctr}=l( [symbol] ,ƒₜ) (5)

The predicted loss of the CTCVR task can be represented as follows:

l_{ctcvr}=l( [symbol] ×z,ƒₜ×ƒᵥ) (6)

Typically, the above-mentioned loss function usually uses the following cross entropy form:

l( [symbol] ,h)=− [symbol] log h−(1− [symbol] )log(1−h) (7)

y in equation (7) refers to a label value in a general sense, and h refers to a prediction score in a general sense. According to equation (7), a gradient of a loss relative to the prediction score h is represented as follows:

$${∇}_{h} l ( y , h ) = \frac{h - y}{h ( 1 - h )} \qquad ( 8 )$$

By separately substituting specific forms of the label values and prediction scores in equations (5) and (6) into the gradient calculation method in equation (8), the following can be obtained:

$${∇}_{{θ}_{ctr}} {l}_{ctr} = \frac{{f}_{t} - y}{{f}_{t} ( 1 - {f}_{t} )} \cdot {g}_{t} \qquad ( 9 )$$

$${∇}_{{θ}_{ctr}} {l}_{ctcvr} = \frac{{f}_{v} {f}_{t} - yz}{{f}_{t} ( 1 - {f}_{v} {f}_{t} )} \cdot {g}_{t} \qquad ( 10 )$$

Equation (9) represents a gradient of the CTR task for the model parameter θ_{ctr} of the CTR branch in the model, and the gradient is referred to as a first gradient; and equation (10) represents a gradient of the CTCVR task for the model parameter θ_{ctr}, and the gradient is referred to as a second gradient, where gₜ is a partial derivative of the prediction function f for the model parameter part θ_{ctr}: gₜ=∂θ_{ctr} ƒ(x; θ_{ctr}, θ_{emb}).

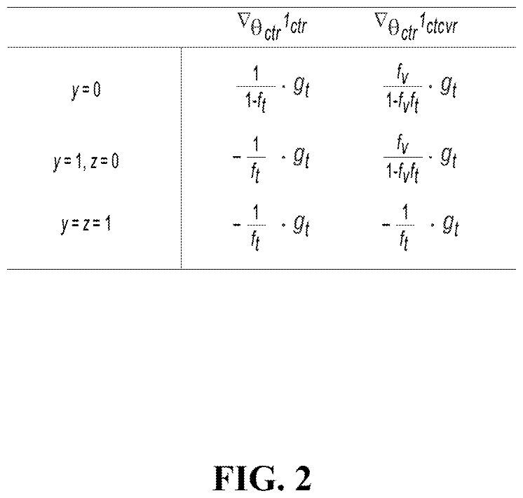

A summary chart shown in FIG. 2 can be obtained by analyzing forms of the first gradient and the second gradient in equations (9) and (10) in cases of various possible values of y and z one by one. As shown in FIG. 2, when y=1 and z=0, as predicted values all fall within a range of (0, 1), the following relationship can be obtained:

$$- \frac{1}{{f}_{t}} < 0 < \frac{{f}_{v}}{1 - {f}_{v} {f}_{t}} \qquad ( 11 )$$

Therefore, regardless of a sign of gₜ, when y=1 and z=0, one of the first gradient and the second gradient must be greater than 0 while the other must be less than 0. In other words, the gradients of the CTR task and the CTCVR task for the model parameter θ_{ctr} are in exactly 180-degree opposite directions. This finding explains a root cause for the difficulties in model training.

The above-mentioned loss function combined with the cross entropy form analyzes generation of the gradient conflict. For other forms of loss functions, for example, forms of a mean square error loss and a hinge loss, the inventor found through analysis that, with these commonly used forms of loss functions, the two auxiliary tasks also produce gradient conflicts at different degrees for the same model parameter part.

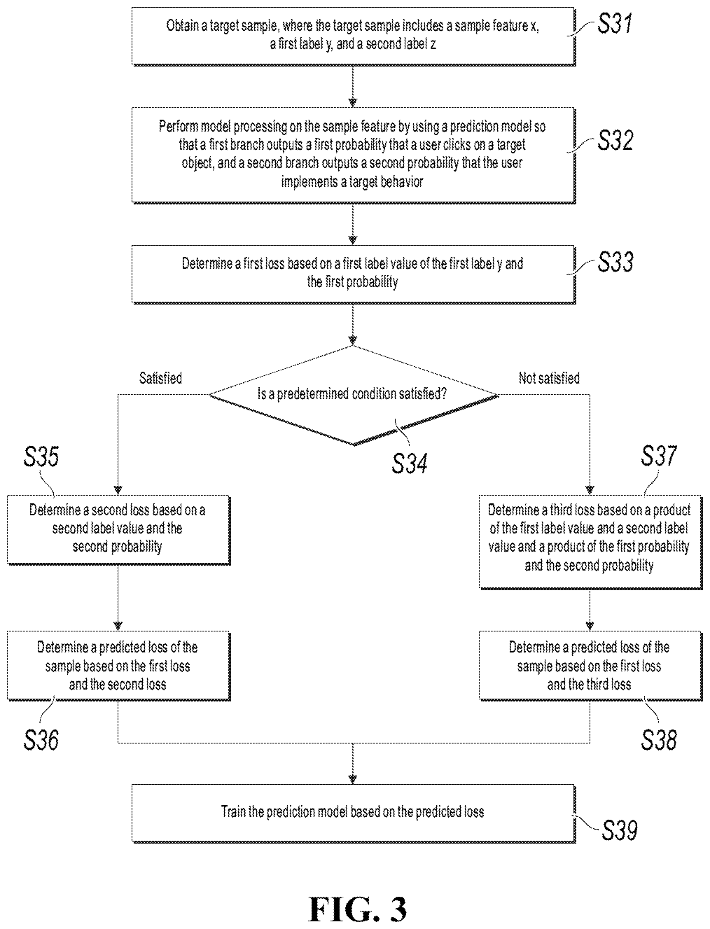

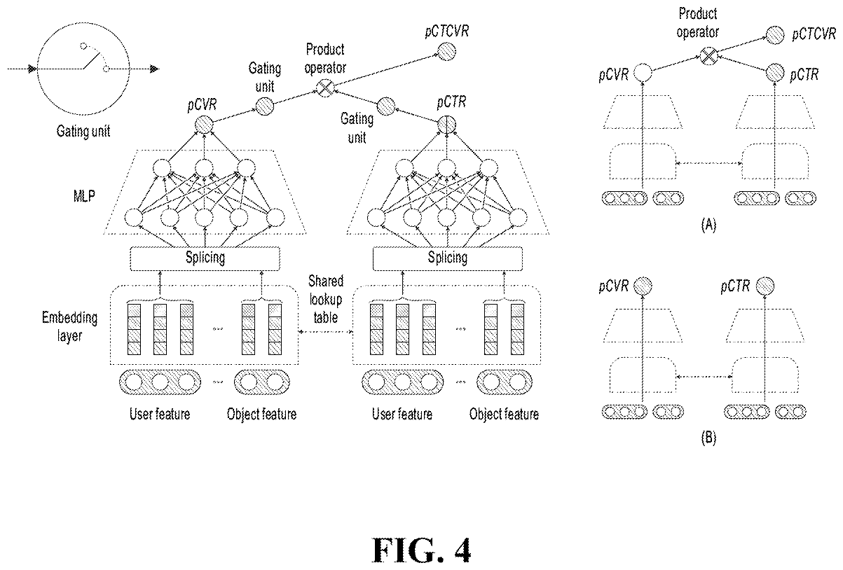

To improve a training effect of the model and alleviate the gradient conflict problem, this specification further proposes an optimized training method. FIG. 3 is a flowchart illustrating a method for training a prediction model, according to an embodiment. A process of the method can be performed by any computing unit, platform, server, or device, etc. that has computing and processing capabilities. As described above, the prediction model is used to predict a probability that a user implements a particular behavior after a click. In terms of structure, the prediction model uses a multi-branch structure similar to the above-mentioned entire-space multi-task model. FIG. 4 is a schematic diagram illustrating a structure and a training process of a prediction model. As shown in FIG. 4, the prediction model includes a first branch and a second branch. The first branch is used to predict a click rate of a user, and corresponds to a CTR prediction branch. The second branch is used to predict a probability that a particular conversion behavior is implemented after a click, and corresponds to a CVR prediction branch. The following describes the optimized training method with reference to FIG. 3 and FIG. 4.

According to the optimized training method, as shown in FIG. 3, first, in step S31, a target sample is obtained, where the target sample includes a sample feature x, a first label y, and a second label z; the first label y indicates whether a user corresponding to the target sample clicks on a target object; and the second label z indicates whether the user implements a target behavior related to the target object after the click.

It can be understood that the target object can be various impression objects in an Internet scenario, for example, a product, an advertisement, an article, music, or a picture. The target behavior can be considered in the corresponding scenario as various behaviors indicating that the user has performed a conversion, for example, a purchase behavior, an add-to-cart behavior, a (music or a picture) download behavior, an add-to-favorites behavior, or a sharing behavior.

Then, in step S32, model processing is performed on the sample feature by using the prediction model so that the first branch of the prediction model outputs a first probability that the user clicks on the target object, and the second branch of the prediction model outputs a second probability that the user implements the target behavior.

To perform the model processing described above, in an embodiment, the prediction model includes an embedding layer for performing embedding processing on the sample feature, as shown in FIG. 4. In the example of FIG. 4, the embedding layer of the two branches performs feature mapping processing by using a shared lookup table. Therefore, it can be considered that the embedding layer is shared by the two branches. Accordingly, a process of the model processing can include first encoding the sample feature x into an embedding vector by using the embedding layer (where a model parameter is θ_{emb}), and inputting the embedding vector separately into the first branch and the second branch. Specifically, in an example, as shown in FIG. 4, the sample feature x includes a user feature of the user and an object feature of the target object. Accordingly, in the embedding layer, the user feature can be encoded into a first vector; and the object feature can be encoded into a second vector; and then, the first vector and the second vector can be aggregated to obtain the embedding vector. A method for the aggregation can include, for example, splicing shown in FIG. 4, or can be a combination method such as summation.

In an example, the sample feature x can further include an interaction feature between the user and the object, e.g., history information describing interaction between the user and the object. In such a case, the embedding layer can further encode the interaction feature to obtain a third vector, and then aggregate all of the first vector, the second vector, and the third vector to obtain the embedding vector corresponding to the target sample.

After obtaining the embedding vector of the target sample based on the embedding layer, the embedding vector is separately input into the first branch and the second branch. The first branch and the second branch can be implemented by using various neural network structures, for example, can be multi-layer perceptrons (MLPs) shown in FIG. 4.

The first branch corresponds to the CTR branch for predicting the click rate of the user. When the embedding vector is input into the first branch, the first branch processes the embedding vector by using a network model parameter θ_{ctr} of the first branch, and outputs the first probability that the user clicks on the target object, i.e. pCTR. The second branch corresponds to the CVR branch for predicting a post-click conversion rate of the user. When the embedding vector is input into the second branch, the second branch processes the embedding vector by using a network model parameter θ_{cvr} of the second branch, and outputs the second probability that the user implements the target behavior after the click, i.e. pCVR.

Then, in step S33, a first loss is determined based on a first label value of the first label and the first probability. The first loss is a predicted loss I_{ctr} corresponding to a CTR prediction task, for example, can be represented in the form in equation (5) described above.

For a loss of another prediction task, a label value-related condition is predetermined, and the another loss is determined in a different way based on whether the condition is satisfied. The predetermined condition can correspond to a case that a gradient conflict easily occurs in a conventional training process.

According to an implementation, the predetermined condition is set as follows: the first label y indicates that the user clicks on the target object. In this implementation, in step S34, it is determined whether the predetermined condition is satisfied, i.e. it is determined whether a value (hereinafter referred to as the first label value) of the first label y is a first value or a second value, where the first value indicates that the user clicks on the target object and the second value indicates that the user does not click on the target object. Typically, the first value is set to 1 and the second value is set to 0.

When the first label value is equal to the first value, i.e. when y=1, the predetermined condition is satisfied, and a first process branch including steps S35 and S36 is executed. In step S35, a second loss is determined based on a value (hereinafter referred to as a second label value) of the second label z and the second probability pCVR. The second loss can be considered as a predicted loss obtained by directly performing CVR prediction, and can be represented as follows:

l_{cvr}=l(z,ƒ(x;θ_{cvr},θ_{emb})) (12)

ƒ(x; θ_{cvr}, θ_{emb}) is a predicted probability output by the CVR branch, i.e. the second probability pCVR, and l(⋅) is a loss function. It can be understood that, a label compared with the second probability pCVR should be y*z. As y=1 has been defined here, the value of the second label z can be directly compared.

Next, in step S36, a predicted loss L corresponding to the target sample is determined based on the first loss l_{ctr} and the second loss l_{cvr}. Specifically, the predicted loss L for the target sample with y=1 can be the sum of the first loss and the second loss:

L=l_{ctr}+l_{cvr} (13)

When the first label value is equal to the second value, i.e. when y=0, the predetermined condition is not satisfied, and a second process branch including steps S37 and S38 is executed. In step S37, a third loss is determined based on a first product of the first label value and the second label value and a second product of the first probability and the second probability. The third loss corresponds to the predicted loss l_{ctcvr} of the above-mentioned pCTCVR task, for example, can be represented in the form in equation (6) described above.

Next, in step S38, a predicted loss L corresponding to the target sample is determined based on the first loss l_{ctr} and the third loss l_{ctcvr}. Specifically, the predicted loss L for the target sample with y=0 can be the sum of the first loss and the third loss:

L=l_{ctr}+l_{ctcvr} (14)

In combination with the above-mentioned two process branches, a predicted loss for a single target sample can be summarized as follows:

L=l_{ctr}+l_{hybrid}=l_{ctr}+y*l_{cvr}+(1−y)*l_{ctcvr} (15)

According to equation (15), the predicted loss can be represented as the sum of the first loss l_{ctr} and a hybrid loss l_{hybrid}. When y=1, the hybrid loss l_{hybrid} is set to the second loss l_{cvr}, and when y=0, the hybrid loss l_{hybrid} is set to the third loss l_{ctcvr}.

Finally, the two process branches proceed to step S39, and the prediction model is trained based on the above-mentioned predicted loss. It can be understood that, the method for determining a predicted loss of a single target sample is described above. When one model update is performed based on a sample set including a batch of samples, a predicted loss is determined for each of the samples by using the above-mentioned method, and model parameters of the prediction model are updated based on the sum of the predicted losses of all the samples.

In another implementation, the predetermined condition is set as follows: the first label y indicates that the user clicks on the target object, and the second label z indicates that the user does not implement the target behavior. In this implementation, in step S34, it is determined whether the predetermined condition is satisfied, i.e. it is determined whether the following are both satisfied: the first label y is set to 1 and the second label z is set to 0.

If the predetermined condition is satisfied, a first process branch including steps S35 and S36 is executed. If the predetermined condition is not satisfied, for example, for other cases except (y=1, z=0), a second process branch including steps S37 and S38 is executed. Specific execution processes of steps S35 to S38 are not repeated.

A core point of the above-mentioned solution lies in that the predicted losses thereof are determined in different ways based on whether the predetermined condition associated with at least the first label y is satisfied. In an embodiment, implementation can be achieved by disposing a gating unit in the prediction model during a training stage. As shown in FIG. 4, the prediction model further includes a gating unit and a product calculation unit (a product operator). When the predetermined condition is not satisfied, for example, when y=0, the gating unit conducts a target path, where the target path is used to transmit the first probability pCTR and the second probability pCVR to the product calculation unit to calculate the second product, i.e. pCTCVR. The conduction of the path means that the third loss l_{ctcvr} can be calculated based on pCTCVR. In this case, a model structure is shown in part (A).

When the predetermined condition is satisfied, for example, when y=1 or when y=1 and z=0, the gating unit blocks the above-mentioned target path so that the first probability pCTR and the second probability pCVR are not transmitted to the product calculation unit to calculate pCTCVR. Instead, the respective predicted losses of the two prediction branches are respectively calculated based on the first probability pCTR/the second probability pCVR, and the model is trained accordingly. In this case, a model structure is transformed into a structure shown in part (B).

As described above, a main gradient conflict of the entire-space multi-task model occurs when y=1 and z=0. In this case, in a form of a cross entropy loss function, the CTR task and the CTCVR task have entirely opposite gradients with respect to the model parameter θ_{ctr}. According to the process in FIG. 3 and the architecture in FIG. 4, it can be seen that, in the optimized training solution, when a gradient conflict 1 easily occurs (corresponding to the case that the predetermined condition is satisfied), the predicted loss l_{cvr} of the CVR task is used to replace the predicted loss of the CTCVR task, and such practice can avoid a gradient conflict between the CTR task and the CTCVR task.

The inventor performed further mathematical analysis and experimental demonstration for the training process in FIG. 3, and results show that a gradient conflict can be effectively avoided and a better training effect can be achieved by using this training process, regardless of a model parameter for the CTR branch or a model parameter for the CVR branch.

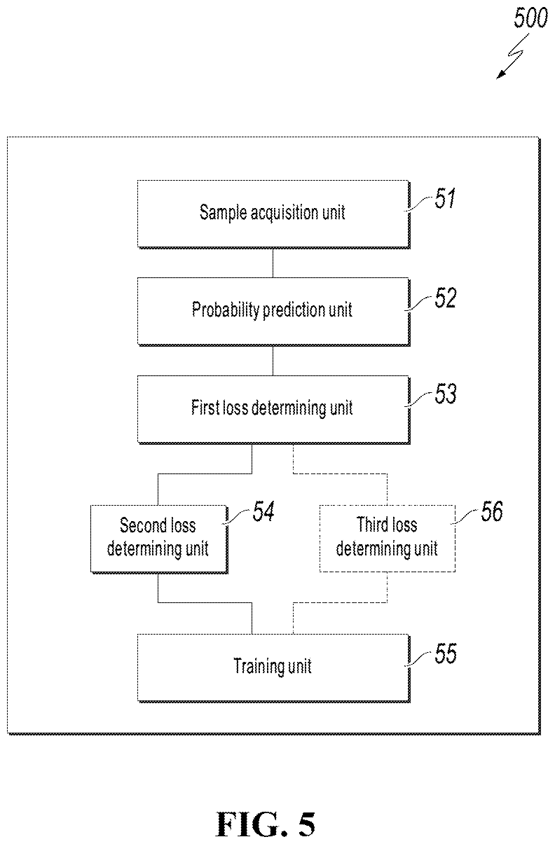

In another aspect, corresponding to the above-mentioned training process, embodiments of this specification further disclose an apparatus for training a prediction model. The apparatus can be deployed in any computing unit, platform, server, or device, etc. that has computing and processing capabilities. FIG. 5 is a schematic structural diagram illustrating a training apparatus, according to an embodiment. The apparatus is configured to train a prediction model, and the prediction model includes a first branch and a second branch. As shown in FIG. 5, the apparatus 500 can include the following:
a sample acquisition unit 51, configured to obtain a target sample, where the target sample includes a sample feature, a first label, and a second label; the first label indicates whether a user corresponding to the target sample clicks on a target object; and the second label indicates whether the user implements a target behavior related to the target object;
a probability prediction unit 52, configured to perform model processing on the sample feature by using the prediction model so that the first branch outputs a first probability that the user clicks on the target object, and the second branch outputs a second probability that the user implements the target behavior;
a first loss determining unit 53, configured to determine a first loss based on a first label value of the first label and the first probability;
a second loss determining unit 54, configured to, when a predetermined condition is satisfied, determine a second loss based on a second label value of the second label and the second probability, and determine a predicted loss of the target sample based on the first loss and the second loss, where the predetermined condition includes the following: the first label value indicates that the user clicks on the target object; and
a training unit 55, configured to train the prediction model based on the predicted loss.

According to an implementation, the apparatus 500 further includes a third loss determining unit 56, configured to, when the predetermined condition is not satisfied, determine a third loss based on a first product of the first label value and the second label value and a second product of the first probability and the second probability; and determine the predicted loss based on the first loss and the third loss.

According to an implementation, the predetermined condition includes the following: the first label value indicates that the user clicks on the target object, and the second label value indicates that the user does not implement the target behavior.

According to an implementation, the prediction model further includes an embedding layer; and the model processing involved in the probability prediction unit 52 includes encoding the sample feature into an embedding vector by using the embedding layer, and inputting the embedding vector separately into the first branch and the second branch.

In an embodiment, the sample feature includes a user feature of the user and an object feature of the target object; and the encoding the sample feature into an embedding vector by using the embedding layer specifically includes the following: encoding the user feature into a first vector; and encoding the object feature into a second vector; and aggregating the first vector and the second vector to obtain the embedding vector.

Further, in an example, the sample feature further includes an interaction feature of the user and the target object; and the encoding the sample feature into an embedding vector by using the embedding layer further includes the following: encoding the interaction feature into a third vector; where the embedding vector is further obtained based on the third vector in this case.

According to an implementation, the prediction model further includes a gating unit and a product calculation unit; and the gating unit blocks a target path when the predetermined condition is satisfied, and conducts the target path when the predetermined condition is not satisfied, where the target path is used to transmit the first probability and the second probability to the product calculation unit to calculate the second product.

In various embodiments, the target behavior includes one of the following: purchase, add to favorites, add to cart, download, and forward.

According to an embodiment of another aspect, a computer-readable storage medium is further provided, where a computer program is stored on the computer-readable storage medium. When the computer program is executed in a computer, the computer is enabled to perform the above-mentioned optimized training method.

According to an embodiment of still another aspect, a computing device is provided, including a memory and a processor, where the memory stores executable code, and the processor implements the above-mentioned optimized training method when executing the executable code.

A person skilled in the art should be able to realize that in one or more of the above-mentioned examples, the functions described in this invention can be implemented by using hardware, software, firmware, or any combination thereof. When software is used for implementation, these functions can be stored in a computer-readable medium or can be transmitted as one or more instructions or one or more pieces of code on a computer-readable medium.

The above-mentioned specific implementations further describe the objectives, technical solutions, and beneficial effects of this invention in detail. It should be understood that the above-mentioned descriptions are merely specific implementations of this invention, and are not intended to limit the protection scope of this invention. Any modification, equivalent replacement, improvement, etc. made based on the technical solutions of this invention shall fall within the protection scope of this invention.

What is claimed is:

1. A computer-implemented method for prediction model training, comprising:
obtaining a target sample, wherein the target sample comprises:
a sample feature, a first label, and a second label, wherein a user corresponds to the target sample, wherein the first label indicates whether a target object is clicked on by the user, and wherein the second label indicates whether the user implements a target behavior related to the target object;
performing model processing on the sample feature by using a prediction model, wherein the prediction model comprises a first branch and a second branch, wherein the first branch outputs a first probability that the target object is clicked on by the user, and wherein the second branch outputs a second probability that the user implements the target behavior;
determining a first loss based on a first label value of the first label and the first probability; and
when a predetermined condition is satisfied:
determining a second loss based on a second label value of the second label and the second probability; and
determining a predicted loss of the target sample based on the first loss and the second loss, wherein the predetermined condition comprises the first label value, which indicates that the target object is clicked on by the user; and
training the prediction model based on the predicted loss.

2. The computer-implemented method of claim 1, comprising:
when the predetermined condition is not satisfied, determining a third loss based on a first product of the first label value and the second label value and a second product of the first probability and the second probability; and
determining the predicted loss based on the first loss and the third loss.

3. The computer-implemented method of claim 1, wherein the predetermined condition comprises:
the second label value indicates that the user does not implement the target behavior.

4. The computer-implemented method of claim 1, wherein:
the prediction model comprises an embedding layer; and
the model processing comprises:
encoding the sample feature into an embedding vector by using the embedding layer; and
inputting the embedding vector separately into the first branch and the second branch.

5. The computer-implemented method of claim 4, wherein:
the sample feature comprises:
a user feature of the user and an object feature of the target object; and
encoding the sample feature into an embedding vector by using the embedding layer, comprises:
encoding the user feature into a first vector;
encoding the object feature into a second vector; and
aggregating the first vector and the second vector to obtain the embedding vector.

6. The computer-implemented method of claim 5, wherein:
the sample feature comprises:
an interaction feature of the user and the target object; and
encoding the sample feature into an embedding vector by using the embedding layer comprises:
encoding the interaction feature into a third vector, wherein the embedding vector is obtained based on the third vector.

7. The computer-implemented method of claim 2, wherein the prediction model comprises:
a gating unit and a product calculation unit, wherein the gating unit blocks a target path when the predetermined condition is satisfied and conducts the target path when the predetermined condition is not satisfied, and wherein the target path is used to transmit the first probability and the second probability to the product calculation unit to calculate the second product.

8. A non-transitory, computer-readable medium storing one or more instructions executable by a computer system to perform one or more operations, comprising:
obtaining a target sample, wherein the target sample comprises:
a sample feature, a first label, and a second label, wherein a user corresponds to the target sample, wherein the first label indicates whether a target object is clicked on by the user, and wherein the second label indicates whether the user implements a target behavior related to the target object;
performing model processing on the sample feature by using a prediction model, wherein the prediction model comprises a first branch and a second branch, wherein the first branch outputs a first probability that the target object is clicked on by the user, and wherein the second branch outputs a second probability that the user implements the target behavior;
determining a first loss based on a first label value of the first label and the first probability; and
when a predetermined condition is satisfied:
determining a second loss based on a second label value of the second label and the second probability; and
determining a predicted loss of the target sample based on the first loss and the second loss, wherein the predetermined condition comprises the first label value, which indicates that the target object is clicked on by the user; and
training the prediction model based on the predicted loss.

9. The non-transitory, computer-readable medium of claim 8, comprising:
when the predetermined condition is not satisfied, determining a third loss based on a first product of the first label value and the second label value and a second product of the first probability and the second probability; and
determining the predicted loss based on the first loss and the third loss.

10. The non-transitory, computer-readable medium of claim 8, wherein the predetermined condition comprises:
the second label value indicates that the user does not implement the target behavior.

11. The non-transitory, computer-readable medium of claim 8, wherein:
the prediction model comprises an embedding layer; and
the model processing comprises:
encoding the sample feature into an embedding vector by using the embedding layer; and
inputting the embedding vector separately into the first branch and the second branch.

12. The non-transitory, computer-readable medium of claim 11, wherein:
the sample feature comprises:
a user feature of the user and an object feature of the target object; and
encoding the sample feature into an embedding vector by using the embedding layer, comprises:
encoding the user feature into a first vector;
encoding the object feature into a second vector; and
aggregating the first vector and the second vector to obtain the embedding vector.

13. The non-transitory, computer-readable medium of claim 12, wherein:
the sample feature comprises:
an interaction feature of the user and the target object; and
encoding the sample feature into an embedding vector by using the embedding layer comprises:
encoding the interaction feature into a third vector, wherein the embedding vector is obtained based on the third vector.

14. The non-transitory, computer-readable medium of claim 9, wherein the prediction model comprises:
a gating unit and a product calculation unit, wherein the gating unit blocks a target path when the predetermined condition is satisfied and conducts the target path when the predetermined condition is not satisfied, and wherein the target path is used to transmit the first probability and the second probability to the product calculation unit to calculate the second product.

15. A computer-implemented system, comprising:
one or more computers; and
one or more computer memory devices interoperably coupled with the one or more computers and having tangible, non-transitory, machine-readable media storing one or more instructions that, when executed by the one or more computers, perform one or more operations, comprising:
obtaining a target sample, wherein the target sample comprises:
a sample feature, a first label, and a second label, wherein a user corresponds to the target sample, wherein the first label indicates whether a target object is clicked on by the user, and wherein the second label indicates whether the user implements a target behavior related to the target object;
performing model processing on the sample feature by using a prediction model, wherein the prediction model comprises a first branch and a second branch, wherein the first branch outputs a first probability that the target object is clicked on by the user, and wherein the second branch outputs a second probability that the user implements the target behavior;
determining a first loss based on a first label value of the first label and the first probability; and
when a predetermined condition is satisfied:
determining a second loss based on a second label value of the second label and the second probability; and
determining a predicted loss of the target sample based on the first loss and the second loss, wherein the predetermined condition comprises the first label value, which indicates that the target object is clicked on by the user; and
training the prediction model based on the predicted loss.

16. The computer-implemented system of claim 15, comprising:
when the predetermined condition is not satisfied, determining a third loss based on a first product of the first label value and the second label value and a second product of the first probability and the second probability; and
determining the predicted loss based on the first loss and the third loss.

17. The computer-implemented system of claim 15, wherein the predetermined condition comprises:
the second label value indicates that the user does not implement the target behavior.

18. The computer-implemented system of claim 15, wherein:
the prediction model comprises an embedding layer; and
the model processing comprises:
encoding the sample feature into an embedding vector by using the embedding layer; and
inputting the embedding vector separately into the first branch and the second branch.

19. The computer-implemented system of claim 18, wherein:
the sample feature comprises:
a user feature of the user and an object feature of the target object; and
encoding the sample feature into an embedding vector by using the embedding layer, comprises:
encoding the user feature into a first vector;
encoding the object feature into a second vector; and
aggregating the first vector and the second vector to obtain the embedding vector.

20. The computer-implemented system of claim 19, wherein:
the sample feature comprises:
an interaction feature of the user and the target object; and
encoding the sample feature into an embedding vector by using the embedding layer comprises:
encoding the interaction feature into a third vector, wherein the embedding vector is obtained based on the third vector.
